(19) United States
(12) Patent Application Publication
(10) Pub. No.: US 2026/0180417 A1
(43) Pub. Date: Jun. 25, 2026

(54) CONTINUOUS CURRENT MONITOR BASED ON LOW-SIDE PILOT POWER DEVICE

(71) Applicant: Renesas Electronics America Inc., Milpitas, CA (US)

(72) Inventors: Ryan Patrick FORAN, Bullock, NC (US); Yashovardhan Rao POTLAPALLI, Cary, NC (US)

(73) Assignee: Renesas Electronics America Inc., Milpitas, CA (US)

(21) Appl. No.: 18/988,403

(22) Filed: Dec. 19, 2024

(51) Int. Cl. H02M 1/00; H02M 3/158

(52) U.S. Cl. CPC H02M 1/0009; H02M 3/158

(57) ABSTRACT

Systems and methods for implementing a continuous current monitor based on a low-side pilot power device is generally described. The semiconductor device includes a first circuit to filter an output signal from a power stage to generate a filtered signal that is coherent with an inductor current through an inductor in the power stage, a second circuit to generate a calibration code, and a third circuit to monitor current from a pilot device integrated in a low-side device of the power stage. The first circuit can calibrate the filtered signal to generate a calibrated signal based on the calibration code and the current from the pilot device. The second circuit can adjust the calibration code based on the calibrated signal. A combination of samples corresponding to the calibrated signal and samples corresponding to the current from the pilot device can recreate the inductor current.

### BACKGROUND

The present disclosure relates in general to semiconductor devices. More specifically, the present disclosure relates to continuous current monitor based on low-side pilot power device.

A voltage regulator or switching converter can convert an input voltage into an output voltage having a desired voltage level. The switching converter (e.g., a buck converter), can include a controller, a pair of gate drivers, and a pair of switches that include a high-side switch and a low-side switch. The controller can provide control signals (e.g., pulse width modulation (PWM) or pulse-frequency modulation (PFM) signals) to a pair of gate drivers. The gate drivers can drive a high-side switch and a low side switch alternately according to the control signal. The alternate switching can convert the Input voltage into the output voltage. The controller can receive feedback information based on voltage and/or current sensed from the output voltage.

### SUMMARY

In one embodiment, a semiconductor device that can implement a continuous current monitor based on a low-side pilot power device is generally described. The semiconductor device can include a first circuit configured to filter an output signal from a power stage to generate a filtered signal that can be coherent with an inductor current through an inductor in the power stage. The semiconductor device can include a second circuit configured to generate a calibration code. The semiconductor device can further include a third circuit configured to monitor current from a pilot device integrated in a low-side (LS) device of the power stage. The first circuit can be further configured to calibrate the filtered signal to generate a calibrated signal. Calibration of the filtered signal can be based on the calibration code generated by the second circuit and the current from the pilot device. The second circuit can be further configured to adjust the calibration code based on the calibrated signal generated by the first circuit. A combination of samples corresponding to the calibrated signal and samples corresponding to the current from the pilot device can recreate the inductor current.

In one embodiment, a system that can implement a continuous current monitor based on a low-side pilot power device is generally described. The system can include a power stage. The system can also include a controller configured to control the power stage. The system can further include a circuit configured to filter an output signal from the power stage to generate a filtered signal that can be coherent with an inductor current through an inductor in the power stage. The circuit can also be configured to monitor current from a pilot device integrated in a low-side (LS) device of the power stage. The circuit can be further configured to calibrate the filtered signal to generate a calibrated signal. Calibration of the filtered signal can be based on a calibration code and the current from the pilot device. The circuit can also be configured to combine samples corresponding to the calibrated signal and samples corresponding to the current from the pilot device. The controller can be further configured to recreate the inductor current based on the combination of the samples.

In one embodiment, a method for monitoring inductor current in a power stage that can implement a continuous current monitor based on a low-side pilot power device is generally described. The method can include filtering an output signal from a power stage to generate a filtered signal that can be coherent with an inductor current through an inductor in the power stage. The method can also include monitoring current from a pilot device integrated in a low-side (LS) device of the power stage. The method can further include calibrating the filtered signal to generate a calibrated signal. Calibration of the filtered signal can be based on a calibration code and the current from the pilot device. The method can also include combining samples corresponding to the calibrated signal and samples corresponding to the current from the pilot device. The method can further include recreating the inductor current based on the combination of the samples.

### BRIEF DESCRIPTION OF THE DRAWINGS

FIG. 1 is a diagram showing a system that can implement continuous current monitor based on low-side pilot power device in one embodiment.

FIG. 2A is a diagram showing an example implementation of a low-side power device in continuous current monitor based on low-side pilot power device in one embodiment.

FIG. 2B is a diagram showing an example transimpedance amplifier in continuous current monitor based on low-side power device in one embodiment.

FIG. 3 is a diagram showing an example implementation of the system shown in FIG. 1 in one embodiment.

FIG. 4 is a diagram showing an example implementation of a sample circuit in continuous current monitor based on low-side power device in one embodiment.

FIG. 5 is a diagram showing an example implementation of a ripple generation circuit in continuous current monitor based on low-side power device in one embodiment.

FIG. 6 is a diagram showing an example implementation of a timing and calibration circuit in continuous current monitor based on low-side power device in one embodiment.

FIG. 7 is a diagram showing example waveforms of signals in an example implementation continuous current monitor based on low-side power device in one embodiment.

FIG. 8 is a flowchart of an example process that can implement continuous current monitor based on low-side power device in one embodiment.

### DETAILED DESCRIPTION

In the following description, numerous specific details are set forth, such as particular structures, components, materials, dimensions, processing steps and techniques, in order to provide an understanding of the various embodiments of the present application. However, it will be appreciated by one of ordinary skill in the art that the various embodiments of the present application may be practiced without these specific details. In other instances, well-known structures or processing steps have not been described in detail in order to avoid obscuring the present application.

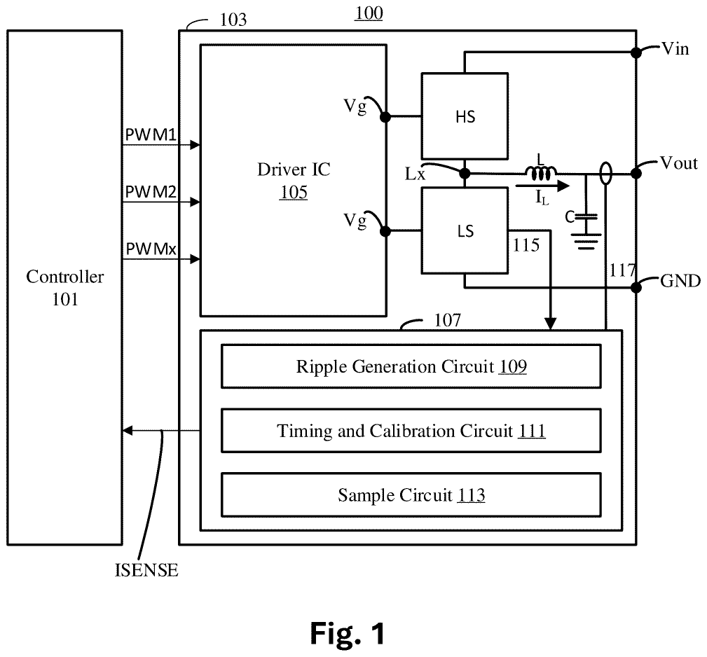

FIG. 1 is a diagram showing a system that can implement continuous current monitor based on low-side pilot power device in one embodiment. A system 100 shown in FIG. 1 can be implemented by one or more semiconductor devices. System 100 can be a voltage regulator system such as a buck regulator. System 100 can include at least a controller 101 and a power stage 103. Power stage 103 can comprise of a driver integrated circuit (IC) 105, a high-side switch labeled as HS, a low-side switch labeled as LS, and a current sense circuit 107. Driver IC 105 can include a driver configured to drive switch HS and another driver configured to drive switch LS. Driver IC 105 can be configured to provide gate voltages Vg to drive switches HS and LS. In one embodiment, switches HS and LS can be field-effect transistors (FETs) such as metal oxide semiconductor field effect transistors (MOSFETs). In other embodiments, switches HS and LS can be diodes or insulated-gate bipolar transistors (IGBTs). Switch HS can be configured to be switched on while LS is switched off, and vice versa. When HS is switched on and LS is switched off, a voltage at a switch node LX between HS and LS can be pulled up to Vin such that the voltage at switch node LX is equivalent to Vin. When HS is switched off and LS is switched on, the voltage at switch node LX can be pulled down to ground, hence the voltage is equivalent to zero. The switching action at node LX can generate a pulsed voltage that can be filtered by an LC network comprising an inductor L and a capacitor C before being output as output voltage Vout.

Controller 101 can be, for example, a processor, microcontroller, central processing unit (CPU), field-programmable gate array (FPGA) or any other circuitry that is configured to control and operate various components in system 100. While described as a CPU in illustrative embodiments, controller 101 is not limited to a CPU in these embodiments and may comprise any other circuitry that is configured to control and operate Driver IC 105. Controller 101 can be configured to generate control signals, such as pulse width modulation (PWM) or pulse frequency modulation (PFM) signals for controlling Driver IC 105 to selectively turn switches HS and LS on and off. For example, in FIG. 1, controller 101 can generate a plurality of PWM signals such as PWM1, PWM2, ... PWMx (hereinafter “PWM signals”).

In a conventional system, a circuit can be configured to monitor the current through the inductor L for various purposes such as obtaining the average value for overcurrent protection (current limit), implementing cycle-by-cycle current limit protection for positive and negative peak values, and adjusting voltage positioning based on the output current. However, because the current in the inductor L is not proportional to the PWM duty ratio, measuring the inductor current can be difficult. One common approach to sensing current is by using a sense resistor in series with the inductor L. However, power can be lost in the resistor. Another approach, using the DC resistance (DCR) of the inductor, generates a signal proportional to the inductor current based on the parasitic resistance of the inductor. However, the DCR is often unknown, changes with temperature requiring correction (usually with a negative temperature coefficient resistor), involves a complex passive network on the board, and has difficulty matching the time constant of the DCR network, leading to poor accuracy during transients. Additionally, measuring the voltage across the parasitic resistance of a field-effect transistor (FET) is another approach, but it also has disadvantages: the resistance is unknown, varies with temperature, and the signal is available when the FET is turned on.

To be described in more detail below, current sense circuit 107 can further comprise of a ripple generation circuit 109, timing and calibration circuit 111, and sample circuit 113. The current sense circuit 107 can be configured to receive voltage and/or current information output from switches HS and LS and through the inductor L. In one embodiment, the switch LS of power stage 103 can comprise of a main MOSFET and a pilot MOSFET. By using a pilot MOSFET integrated into the main MOSFET of the switch LS, the current in the pilot MOSFET is proportional to the current in the switch LS when switch LS is on. Current sense circuit 107 can be configured to receive signals 115 from the switch LS and further can generate a continuous and calibrated waveform coherent with the inductor current, i.e., the difference in phase between the continuous waveform and the inductor current is consistent and constant. This continuous waveform can further be scaled to match the inductor current. The ripple generation circuit 109 can be configured to filter the signals output from the LX node and generate a triangle waveform coherent with the inductor current I_{L} based on the signals output from the LX node. Sample circuit 113 can be configured to receive signals 115 that can include the current output by the switch LS comprising of the pilot FET and timing and calibration circuit 111 can be configured to calibrate the timing of the generated triangle waveform with the pilot FET current.

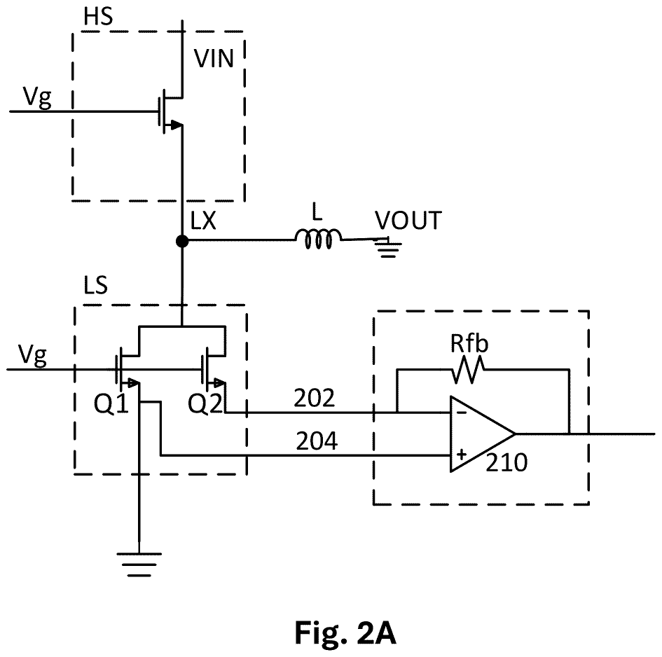

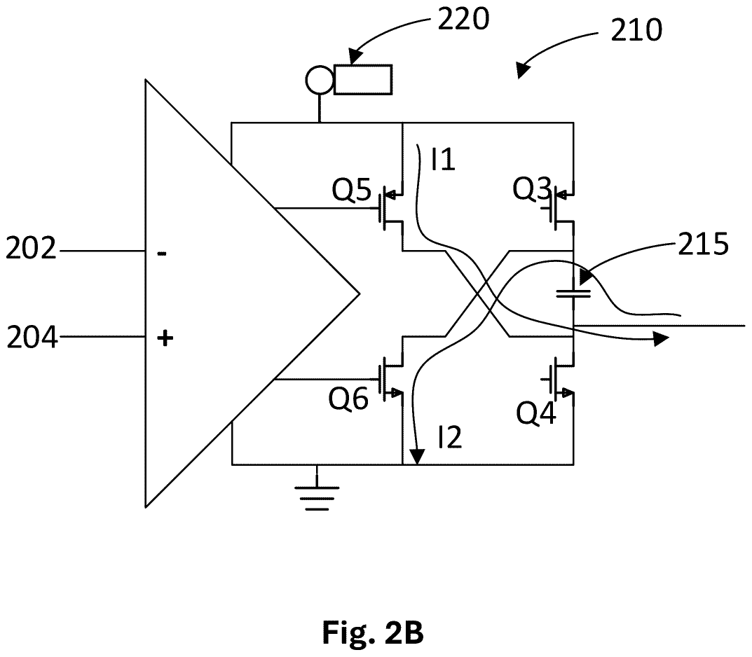

FIG. 2A is a diagram showing a system that can implement current sensing in another example embodiment. Descriptions of FIG. 2A may reference components shown in FIG. 1. In this example embodiment, switch LS can include a low side FET Q1 with an integrated pilot FET Q2. The pilot FET Q2 shares a common drain and a common gate as the main FET Q1. In one embodiment, the pilot FET Q2 can be smaller than main FET Q1 to provide a proportional current through pilot FET Q2 in relation to main FET Q1. Signals 115 being received by current sense circuit 107 can include the pilot FET current 202 output from the source of the pilot FET Q2 and the main FET current 204 output from the source of the main FET Q1 can be received by a transimpedance amplifier 210 (hereinafter “TZA 210”) comprised in sample circuit 113 of current sense circuit 107.

By using TZA 210, the sources of both the main FET Q1 and the pilot FET Q2 can maintain the same voltage potential. When all terminals of both FETS Q1, Q2 have equivalent voltages, the current ratio between the main FET Q1 and pilot FET Q2 can be determined by the area size of each FET Q1, Q2. The pilot FET current 202 flowing through the pilot FET Q2 is directed through a feedback resistor Rfb connected in parallel to TZA 210. The voltage produced at the TZA 210 output is proportional to the main FET current 204 in the main FET Q1. Specifically, the output voltage from TZA 210 is equal to the main FET current 204 flowing through main FET Q2 divided by the ratio of the area of main FET Q1 to the area of the pilot FET Q2, multiplied by the transimpedance resistor Rfb. The configuration exemplified by FIG. 2A provides stability of the current ratio over varying temperatures and gate driver voltages. In addition, the shared common drain by the pilot FET Q2 and the main FET Q1 causes both FETs Q1 and Q2 to experience similar stress conditions resulting in minimal lifetime drift in the ratio.

In an aspect, when main FET Q1 and pilot FET Q2 share a common drain, the configuration requires the TZA 210 output voltage to be capable of going below ground potential for negative currents. Negative currents occur when current flows from the source to the drain of the FETs, which can happen during negative inductor current (e.g., current flowing from Vout, through the inductor, through Q1 to ground). Conventionally, a trans-impedance amplifier can incorporate a negative power supply to handle this bidirectional current flow. However, this would require additional electrical components and additional board space. To be described in more detail below, in FIG. 2b, the TZA 210 can be configured to receive the pilot FET current 202 and main FET current 204 from the source of FETs Q1 and Q2 without the need of a negative power supply.

FIG. 2B is a diagram of a transimpedance amplifier that can implement current sensing in an example embodiment. Descriptions of FIG. 2B may reference components shown in FIGS. 1 and 2A. In FIG. 2B, TZA 210 can include switches Q3, Q4, Q5 and Q6 and a capacitor 215. The TZA 210 can receive the pilot FET current 202 at the inverting input and can receive main FET current 204 at the non-inverting input. Instead of requiring a negative power supply to be connected to a trans-impedance amplifier, the TZA 210 can include a capacitor 215 that can be an on-die capacitor, i.e., integrated onto the TZA 210. The TZA 210 is configured to source current I1 directly from a supply 220 (e.g., 5V supply) through switch Q5, but sinks current I2, which can be a negative current, through switch Q6 delivered by capacitor 215. The capacitor 215 is configured to be charged via switches Q3 and Q4 receiving charge current at their gates.

As negative current is sunk through switch Q6, the voltage across the capacitor 215 will deplete until there is no longer sufficient charge on the capacitor 215 to maintain the output voltage VOUT. Every switching cycle, capacitor 215 is charged and depletes only when the output voltage of TZA 210 needs to be near zero or negative. A circuit component such as a comparator can be connected to the TZA 210 and can be configured to detect when capacitor 215 has depleted enough to no longer contain sufficient charge to maintain the output voltage.

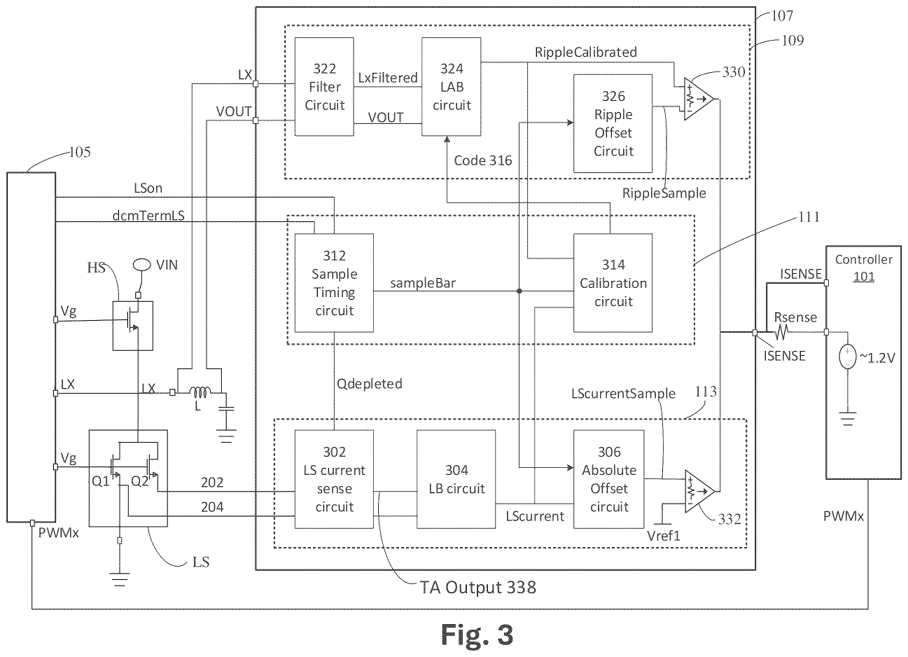

FIG. 3 is a diagram showing an example implementation of the system shown in FIG. 1 in one embodiment. Descriptions of FIG. 3 may reference components shown in FIGS. 1-2B. In FIG. 3, sample circuit 113 of current sense circuit 107 can comprise of a low-side (LS) current sense circuit 302, a level shift-buffer (LB) circuit 304, and an absolute offset circuit 306. Ripple generation circuit 109 of current sense circuit 107 can comprise of a filter circuit 322, a level shift-attenuation-buffer (LAB) circuit 324, and a ripple offset circuit 326. Timing and calibration circuit 111 of current sense circuit 107 can comprise of a sample timing circuit 312 and a calibration circuit 314.

Sample circuit 113 can be configured to receive the pilot FET current 202. The pilot FET current 202 can be received by the TZA 210 shown in FIG. 2B, where TZA 210 can be integrated in LS current sense circuit 302. LB circuit 304 can be configured to generate a signal LScurrent that is proportional to the pilot FET current 202 from the pilot FET Q2. Absolute offset circuit 306 can be configured to sample the signal LScurrent and output a signal LScurrentSample. A transconductance amplifier 332 can take the difference between LScurrentSample and a reference voltage Vref1, amplifying this difference to generate a proportional output current at a current-sensing node or pin labeled as ISENSE.

Ripple generation circuit 109 can be configured to apply a low-pass filter on the voltage at node LX relative to output voltage VOUT, and can also produce a filtered signal LxFiltered that has a waveform resembling the current through the inductor L. The waveform of filtered signal LxFiltered can be a triangle waveform comprising of AC and DC properties. LAB circuit 324 can generate a calibrated signal RippleCalibrated by level shifting, attenuating and/or buffering the filtered signal LxFiltered. LAB circuit 324 can level shift and attenuate the calibrated signal LxFiltered until the downslope of LxFiltered matches the downslope of LScurrent. The calibrated signal RippleCalibrated can be provided to calibration circuit 314, and the level or amount of attenuation performed by LAB circuit 324 is dependent on both the signal LScurrent and signal RippleCalibrated received at calibration circuit 314 (described below). The output of calibration circuit 314 can be a calibration code 316 and can be fed back to LAB circuit 324 and LAB circuit 324 can adjust an amplitude of LxFiltered based on the calibration code 316 received from calibration circuit 314 to generate the calibrated signal RippleCalibrated. The calibrated signal RippleCalibrated can also be sampled by ripple offset circuit 326 to generate a sample signal RippleSample.

By way of example, the calibration performed by ripple generation circuit 109 is a continuous loop where LxFiltered is calibrated by attenuation using calibration code 316, the calibrated LxFiltered is provided to calibration circuit 314 as the signal RippleCalibrated, the calibration circuit 314 adjust the calibration code 316 based on RippleCalibrated (and LScurrent), and the adjusted calibration code 316 is then used again by ripple generation circuit 109 to calibrate LxFiltered. The continuous loop allows the inductor current through L to be continuously monitored and calibrated while minimizing quiescent current consumption, and provides relatively high tolerance against missing samples from the pilot FET.

The sample timing circuit 312 can be configured to generate a signal sampleBar for controlling the timing of when absolute offset circuit 306 can sample signal LScurrent and generate signal LScurrentSample. The signal sampleBar can also be used for controlling the timing of when ripple offset circuit 326 can sample signal RippleCalibrated and generate signal RippleSample. The timing can be determined by the LSon signal, which indicates when the LS switch is turned ON, and adjusted for dead time using the dcmTermLS signal. The timing of when the capacitor C in TZA 210 is depleted can be indicated by a charge depletion signal Qdepleted, generated by LS current sense circuit 302, and can be further used by timing circuit 312 to generate sampleBar.

Using a transconductance amplifier 330, the signal RippleSample can be subtracted from the RippleCalibrated to remove DC components and amplified, and the output from transconductance amplifier 330 can be summed with the output from transconductance amplifier 332 at the ISENSE output. The total combined voltage from transconductance amplifier 330, 332 at the ISENSE output can allow controller 101 to recreate the inductor current through inductor L with a known scale that can be set by an external resistor Rsense.

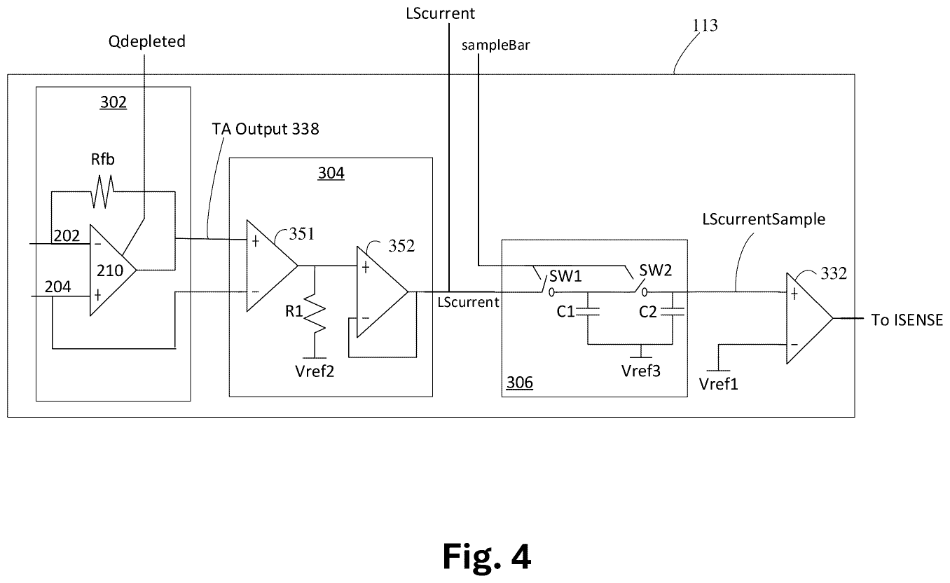

FIG. 4 is a diagram showing an example implementation of a sample circuit in continuous current monitor based on low-side power device in one embodiment. Descriptions of FIG. 4 may reference components shown in FIGS. 1-3. FIG. 4 illustrates the sample circuit 113 comprised in current sense circuit 107. LS current sense circuit 302 can comprise of TZA 210 and feedback resistor Rfb. As described and shown in FIGS. 2A and 2B, LS current sense circuit 302 is configured to receive the signal from the common drain pilot FET Q2.

LB circuit 304 can comprise of electrical components such as amplifiers 351, 352 and a resistor R. LB circuit 304 can be configured to receive a transimpedance amplifier (TA) output 338 and the main FET current 204 at the inputs of the amplifier 351. Amplifier 351 can generate an output, and application of a predetermined reference voltage Vref2 to the output of the amplifier 351 through resistor R can level shift the output signal from amplifier 351 to centered around Vref2. The amplifier 352 in LB circuit 304 can be configured as a buffer. Utilizing the amplifier 351 and the amplifier 352, the LB circuit 304 can provide a level shifted output voltage labeled as current LScurrent.

Absolute offset circuit 306 can comprise of electrical components such as switches SW1, SW2 and capacitors C1, C2. The absolute offset circuit 306 can be configured as a switched capacitor circuit. The two switches SW1, SW2 can be controlled by a signal, such as sampleBar generated by sample timing circuit 312. Timing signals such as sampleBar can be derived from the PWM signals output by controller 101 to maintain synchronization. The sampleBar signal can be a repeating square wave alternating between high and low voltages. The rising and falling of the sampleBar signal can trigger the opening and closing of switches SW1, SW2. Absolute offset circuit 306 can be configured to receive signal LScurrent outputted by LB circuit 304. The absolute offset circuit 306 can be configured to sample the signal LScurrent using the capacitors C1, C2 when the switches SW1, SW2 are switched to connect the input of absolute offset circuit 306, that is receiving LScurrent, to an output of absolute offset circuit 306. The capacitors C1, C2 can hold the sampled signal from LScurrent until the sampleBar signal triggers switches SW1, SW2 to disconnect the input of absolute offset circuit 306 from the output of absolute offset circuit 306 to discharge the capacitors C1, C2 to release the sampled and held signal LScurrent to transconductance amplifier 332 as signal LScurrentSample. Transconductance amplifier 332 can compare the signal LScurrentSample to reference voltage Vref1 to generate an output signal, proportional to the voltage difference of LsCurrentSample and reference voltage Vref1, towards ISENSE as shown in FIG. 3. Capacitors C1, C2 can be connected to a reference voltage Vref3 for noise filtering and stabilizing the voltages being held by capacitors C1, C2.

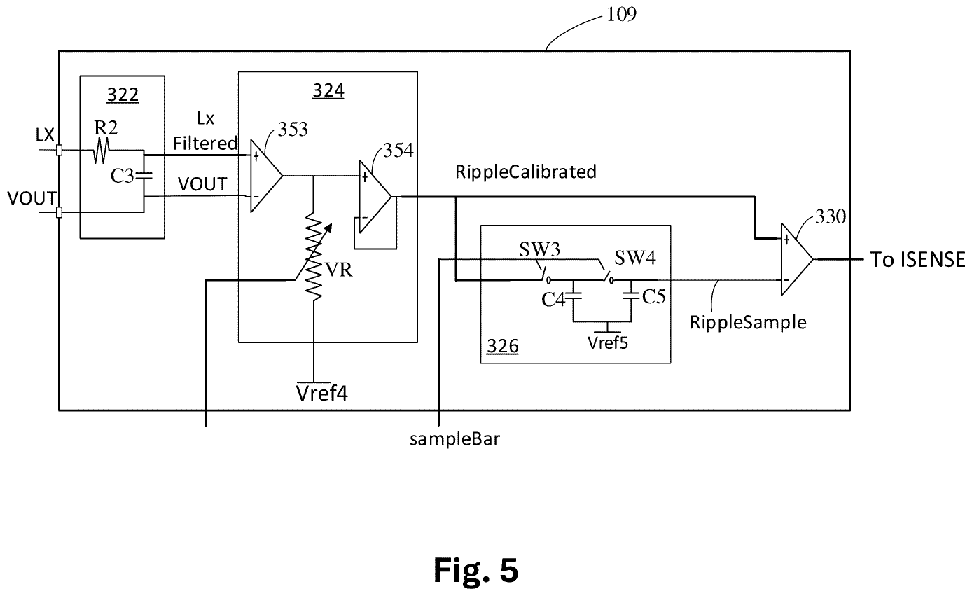

FIG. 5 is a diagram showing an example implementation of a ripple generation circuit in continuous current monitor based on low-side power device in one embodiment. Descriptions of FIG. 5 may reference components shown in FIGS. 1-4. FIG. 5 illustrates details of the components in ripple generation circuit 109. Filter circuit 322 can comprise of electrical components such as a resistor R2 and capacitor C3 configured as a low-pass filter circuit. Filter circuit 322 can be configured to receive output voltage VOUT and the voltage at the LX node. The low-pass filter comprising of resistor R2 and capacitor C3 can smooth high-frequency noise and transients from the LX node, resulting in a filtered signal LxFiltered. Because the filter circuit 322 has the same continuous inputs as the inductor, the resulting waveform of LxFiltered has a triangle waveform coherent with the current through the inductor L.

LAB circuit 324 can include electrical components such as amplifiers 353, 354 and a variable resistor VR. LAB circuit 324 can be configured to receive the LxFiltered signal from filter circuit 322 and can process the LxFiltered signal to produce a level-shifted output signal. The amplifier 353 can be configured to shift the LxFiltered signal so that it aligns and centers the signal around a common mode voltage Vref4. Resistor VR can adjust the degree of attenuation applied to the signal LxFiltered, ensuring that the downslope of LxFiltered signal matches that of the current measured from the pilot FET Q2 in system 100. The adjustments made by the resistor VR can be based on signals output by calibration circuit 314. The amplifier 354 can be configured as a buffer, to maintain the level-shifted signal. This configuration allows the signal to be presented at a known voltage level suitable for further processing as signal RippleCalibrated.

Ripple offset circuit 326 can comprise of switches SW3, SW4 and capacitors C4, C5 arranged in a sample-and-hold configuration. Ripple offset circuit 326 can be configured to sample the signal RippleCalibrated at specific intervals, as determined by clock signal CLK. The switches SW3, SW4 can be controlled to open or close in response to the transitions of the clock signal CLK, allowing capacitors C4, C5 to store a charge representing the sampled value of RippleCalibrated. Ripple offset circuit 326 can be configured to update the sample-and-hold samples at the end of the off-time of the power converter or when the TZA capacitor becomes fully depleted. The signal RippleSample can then be output to transconductance amplifier 330 to remove the DC component RippleSample from RippleCalibrated. By way of example, when the switches SW3, SW4 are switched to connect the input of ripple offset circuit 326 to the output of ripple offset circuit 326, the signal RippleCalibrated can be sampled and held by capacitors C4, C5. The capacitors C4, C5 can hold the sampled signal from RippleCalibrated until the sampleBar signal triggers switches SW3, SW4 to disconnect the input of ripple offset circuit 326 from the output of ripple offset circuit 326 to discharge the capacitors C4, C5 to release the sampled and held signal RippleCalibrated to transconductance amplifier 330 as signal RippleSample. Transconductance amplifier 330 can compare the signal RippleCalibrated with RippleSample to generate an output signal proportional to the difference between the signal RippleCalibrated and RippleSample, towards ISENSE as shown in FIG. 3. Capacitors C4, C5 can be connected to a reference voltage Vref5 for noise filtering and stabilizing the voltages being held by capacitors C4, C5.

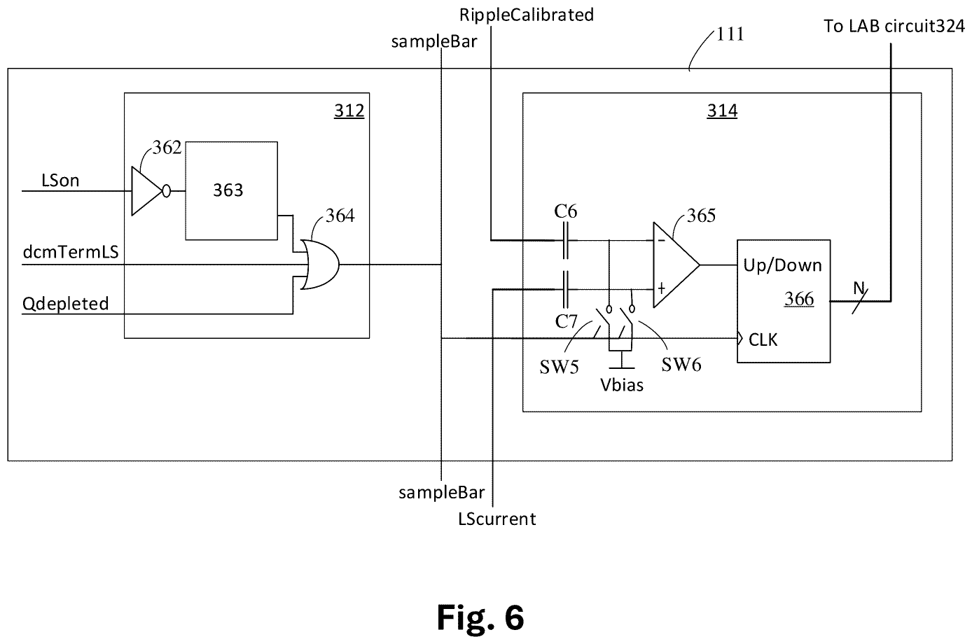

FIG. 6 is a diagram showing an example implementation of a timing and calibration circuit in continuous current monitor based on low-side power device in one embodiment. Descriptions of FIG. 6 may reference components shown in FIGS. 1-5. FIG. 6 illustrates details of the components in the timing and calibration circuit 111. Timing and calibration circuit 111 can comprise of the sample timing circuit 312 and the calibration circuit 314. Sample timing circuit 312 can be configured to coordinate the sampling of downslopes during each switching cycle. Sample timing circuit 312 can include logical components such as an inverter 362, a timing control block 363, and an OR gate 364. These components can be configured to detect the transition events related to the LS switch, such as when the LS switch is about to turn off, indicated by signals like PWM and FCCM. During each switching cycle, sample timing circuit 312 can generate the sample initiation signal sampleBar, after a fixed blanking period following the LS turn-on. This blanking period allows the transient effects from the LS switch to settle before accurate sampling begins. The signal sampleBar can be used to control when the sampling process starts, ensuring that the timing of signal sampling aligns with the intended timing intervals in the switching cycle.

Calibration circuit 314 can comprise of capacitors C6, C7, switches SW5, SW6, a comparator 365, and a logic control circuit 366. Calibration circuit 314 can be configured to sample the downslope of both the measured pilot current LScurrent and the calibrated RippleCalibrated signal. Calibration circuit 314 can sample the downslope of the calibrated signal RippleCalibrated and the sensed pilot current LScurrent once a fixed blanking time has elapsed. The fixed blanking time can be a fixed delay after the LS is turned on to allow for settling of the TZA output signal. The comparator 365 can be used to compare the sampled downslope values of RippleCalibrated and LScurrent and output a voltage representing a degree to which the downslope characteristics of RippleCalibrated and LScurrent align. At the end of each off-time (e.g., time in which LS device stays off), the comparator 365 output can be latched using the switches SW6, SW7, providing an indication of whether the attenuation level of the ripple should be adjusted (e.g., increase or decrease). The comparator output from comparator 365 can be provided to an Up/Down input pin of logic control circuit 366. Logic control circuit 366, based on the output from comparator 365, can control and adjust the calibration settings to either increase or decrease the amplitude of the ripple signal RippleCalibrated. The output of logic control circuit 366 can be an N-bit digital signal, and the N-bit digital signal can be provided to LAB circuit 324 to adjust the variable resistor VR in LAB circuit 324 for adjusting the level shifting performed by LAB circuit 324. The N-bit digital signal being outputted by logic control circuit 366 can be one of two calibration codes (e.g., in the form of digital code)—one being greater than a predefined optimal attenuation value and the other one being less than the predefined optimal attenuation value. The continuous calibration process to align the downslope of RippleCalibrated with that of LScurrent can maintain precision over time, with the attenuation values settling or converging to the predefined optimal attenuation value between the two calibration codes that can be outputted by logic control circuit 366. By iteratively adjusting the ripple amplitude through timing and calibration circuit, the calibration circuit 314 can ensure that RippleCalibrated remains accurate relative to the expected behavior of the pilot current LScurrent, thus improving the system's overall stability and current measurement accuracy.

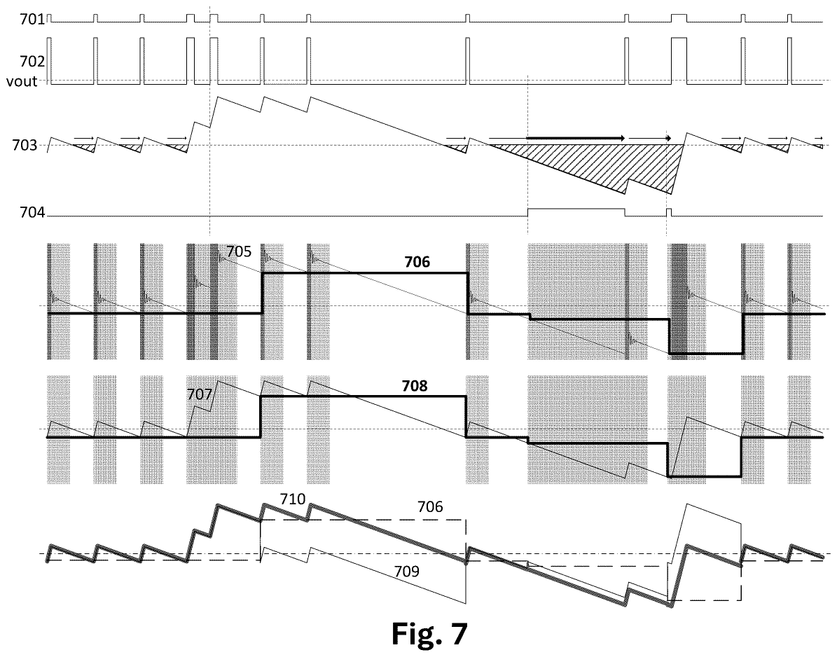

FIG. 7 is a diagram showing example waveforms of signals in an example implementation continuous current monitor based on low-side power device in one embodiment. Descriptions of FIG. 7 may reference components shown in FIGS. 1-6. FIG. 7 illustrates waveforms of the signals generated in system 100 during active switching cycles.

Waveform 701 is the PWM signal generated by controller 101 corresponding to the switching events of the switches LS and HS. When waveform 701 is high, it triggers the switch LS to turn off, allowing the switch HS to turn on, resulting in an increase in the LX node voltage. When PWM goes low, the LS switch is turned on, pulling the LX node to ground. The switching of the PWM signal directly impacts the voltage at the LX node, which fluctuates between Vin and ground, creating a pulsed voltage waveform 702.

The waveform 703 represents the current through the inductor L. Waveform 703 shown in FIG. 7 reflects the triangular current waveform characteristic of a buck converter. When the LS switch is on, the inductor current increases as energy is stored in the inductor L. When the LS switch turns off and the HS switch turns on, the inductor current decreases as the stored energy is released into the load. The triangular shape of the inductor current results from the continuous charging and discharging of the inductor L during the switching cycles of signal PWM.

Another waveform in FIG. 7 is the Qdepleted signal illustrated by waveform 704, which indicates when the charge stored in the capacitor in TZA 210 is fully depleted. The Qdepleted signal can represent an abnormal or transient condition occurring during extremely long off-times, such as when the LS switch remains on longer than usual. Under these conditions, calibration comparisons can occur immediately upon the assertion of the Qdepleted signal, such as before the TZA 210 output becomes invalid. By way of example, the clock input of logic control circuit 366 is strobed at the moment the signal Qdepleted asserts, locking in the output of comparator 365 without waiting for the PWM signal to go high (which prompts sampleBar to assert). This behavior is a result of the TZA 210 being absent of a negative power supply. As seen in the diagram, the Qdepleted signal, waveform 704, aligns with the point where the inductor current, waveform 703, decreases to a minimum, allowing the sampling circuit to capture accurate values for calibration.

The LScurrent and LScurrentSample signals are represented as waveforms 705 and 706 respectively. Waveform 705 illustrates the TA output 338 during each cycle, i.e., a representation of the inductor current when the LS switch is ON, while waveform 706 represents the sampled values that are held during the sampling window. These sampled values remain constant during the hold phase, providing a stable output for comparison with the ripple signal. The RippleCalibrated and RippleSample signals, represented as waveforms 707 and 708 respectively, show the AC component of the inductor current that has been processed through the LAB circuit and sampled in synchronization with the LScurrentSample.

The waveform 709 reflects the difference between waveforms 707 and 708, or RippleSample and RippleCalibrated. The waveform 709 is illustrated on top of waveform 706 representing the LScurrentSample signal. When the LScurrentSample signal is output from sample circuit 113 and summed with the difference between RippleSample and RippleCalibrated, as shown by waveform 709, the summed waveform at the ISENSE output is illustrated by waveform 710.

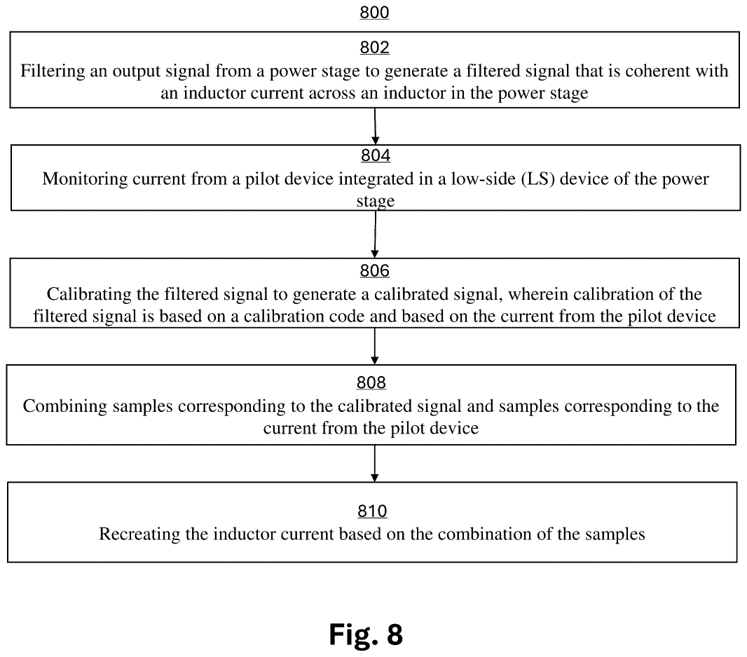

FIG. 8 is a flowchart of an example process that can implement continuous current monitor based on low-side power device in one embodiment. Descriptions of FIG. 8 may reference components shown in FIGS. 1-7. The process 800 can include one or more operations, actions, or functions as illustrated by one or more of blocks 802, 804, 806, 808, and 810. Although illustrated as discrete blocks, various blocks can be divided into additional blocks, combined into fewer blocks, eliminated, performed in different order, or performed in parallel, depending on the desired implementation.

Process 800 can be performed by a regulator described herein, such as one of the regulators in system 100 described in the present disclosure. Process 800 can begin at block 802. At block 802, a voltage regulator circuit can filter an output signal from a power stage to generate a filtered signal that is coherent with an inductor current through an inductor in the power stage. The process 800 can continue from block 802 to block 804. At block 804, the circuit can monitor current from a pilot device integrated in a low-side (LS) device of the power stage. The process 800 can continue from block 804 to block 806. At block 806, the circuit can calibrate the filtered signal to generate a calibrated signal. Calibration of the filtered signal can be based on a calibration code and the current from the pilot device. The process 800 can continue from block 806 to block 808. At block 808, the circuit can combine samples corresponding to the calibrated signal and samples corresponding to the current from the pilot device. The process 800 can continue from block 808 to block 810. At block 810, the circuit can recreate the inductor current based on the combination of the samples.

In another embodiment, the method can further comprise generating the calibration code and adjusting the calibration code based on the calibrated signal.

In another embodiment, the method can further comprise inputting the current from the pilot device and a current of the LS device to a transimpedance amplifier. The method can further comprise sampling a signal generated by the transimpedance amplifier according to a clock signal and outputting samples of the signal generated by the transimpedance amplifier to a current sensing node that combines samples of the signal generated by the transimpedance amplifier with samples corresponding to the calibrated signal.

In another embodiment, the method can further comprise applying a low-pass filter on the output signal from the power stage to generate the filtered signal. The method can further comprise level shifting the filtered signal to generate a first level shifted signal and attenuating the first level shifted signal until a downslope of the first level shifted signal matches a downslope of a second level shifted signal. The second level shifted signal can be level shifted from the current from the pilot device. An amount of attenuation of the first level shifted signal can be based on the calibration code. The method can further comprise sampling the attenuated first level shifted signal according to a clock signal and outputting samples of the attenuated first level shifted signal to a current sensing node that combines samples of the attenuated first level shifted signal with samples corresponding to the current from the pilot device.

In another embodiment, the method can further comprise sampling a downslope of the current from the pilot device and sampling a downslope of the calibrated signal. The method can further comprise comparing the sampled downslope of the current from the pilot device and the sampled downslope of the calibrated signal. The method can further comprise generating the calibration code based on a result of the comparison. The calibration code can indicate whether to increase or to decrease an amplitude of the filtered signal to generate the calibrated signal.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

### EXAMPLES

Example 1: A semiconductor device comprising a first circuit configured to filter an output signal from a power stage to generate a filtered signal that is coherent with an inductor current through an inductor in the power stage; a second circuit configured to generate a calibration code; a third circuit configured to monitor current from a pilot device integrated in a low-side (LS) device of the power stage; and the first circuit is further configured to calibrate the filtered signal to generate a calibrated signal, wherein calibration of the filtered signal is based on the calibration code generated by the second circuit and based on the current from the pilot device; and the second circuit is further configured to adjust the calibration code based on the calibrated signal generated by the first circuit, wherein a combination of samples corresponding to the calibrated signal and samples corresponding to the current from the pilot device recreates the inductor current.

Example 2: The semiconductor device of example 1, wherein the third circuit comprises a feedback resistor; a transimpedance amplifier connected in parallel to the feedback resistor, wherein the transimpedance amplifier comprises an on-die capacitor, and the transimpedance amplifier is configured to maintain the same voltage potential between the LS device and the pilot device such that all terminals of the LS device and the pilot device have equivalent voltages; output a voltage equivalent to a product of a resistance of the feedback resistor and a scaled current, wherein the scaled current is determined by dividing a current flowing through the LS device by a ratio of an area of the LS device to an area of the pilot device; and sink negative current through the on-die capacitor.

Example 3: The semiconductor device of any one of examples 1 to 2, wherein the pilot device shares a common drain and a common gate with the LS device of the power stage.

Example 4: The semiconductor device of any one of examples 1 to 3, wherein the pilot device is smaller than the LS device in the power stage.

Example 5: The semiconductor device of any one of examples 1 to 4, wherein the third circuit is further configured to input the current from the pilot device and a current of the LS device to a transimpedance amplifier; sample a signal generated by the transimpedance amplifier based on the current from the pilot device and the current of the LS device according to a clock signal generated by the second circuit; and output samples of the signal generated by the transimpedance amplifier to a current sensing node that combines samples of the signal generated by the transimpedance amplifier with samples corresponding to the calibrated signal.

Example 6: The semiconductor device of any one of examples 1 to 5, wherein the first circuit is further configured to apply a low-pass filter on the output signal from the power stage to generate the filtered signal; level shifting the filtered signal to generate a first level shifted signal; attenuate the first level shifted signal until a downslope of the first level shifted signal matches a downslope of a second level shifted signal, wherein the second level shifted signal is generated by the third circuit by level shifting the current from the pilot device, and wherein an amount of attenuation of the first level shifted signal is based on the calibration code; sample the attenuated first level shifted signal according to a clock signal generated by the second circuit; and output samples of the attenuated first level shifted signal to a current sensing node that combines samples of the attenuated first level shifted signal with samples corresponding to the current from the pilot device.

Example 7: The semiconductor device of any one of examples 1 to 6, wherein the third circuit is configured to generate a charge depletion signal indicating whether the LS device is on or off; the second circuit is configured to generate a clock signal based on the charge depletion signal; and the first circuit, the second circuit, and the third circuit are configured to perform sampling according to the clock signal.

Example 8: The semiconductor device of any one of examples 1 to 7, wherein the second circuit is configured to sample a downslope of the current from the pilot device monitored by the third circuit; sample a downslope of the calibrated signal generated by the first circuit; compare the sampled downslope of the current of the pilot device and the sampled downslope of the calibrated signal; and generate the calibration code based on a result of the comparison, wherein the calibration code indicates to the first circuit to increase or to decrease an amplitude of the filtered signal to generate the calibrated signal.

Example 9: A system comprising a power stage; a controller configured to control the power stage; a circuit configured to filter an output signal from the power stage to generate a filtered signal that is coherent with an inductor current through an inductor in the power stage; monitor current from a pilot device integrated in a low-side (LS) device of the power stage; calibrate the filtered signal to generate a calibrated signal, wherein calibration of the filtered signal is based on a calibration code and based on the current from the pilot device; combine samples corresponding to the calibrated signal and samples corresponding to the current from the pilot device; and the controller is further configured to recreate the inductor current based on the combination of the samples.

Example 10: The system of example 9, wherein the circuit is configured to generate the calibration code; and adjust the calibration code based on the calibrated signal.

Example 11: The system of any one of examples 9 to 10, wherein the circuit comprises a feedback resistor; a transimpedance amplifier connected in parallel to the feedback resistor, wherein the transimpedance amplifier comprises an on-die capacitor, and the transimpedance amplifier is configured to maintain the same voltage potential between the LS device and the pilot device such that all terminals of the LS device and the pilot device have equivalent voltages; output a voltage equivalent to a product of a resistance of the feedback resistor and a scaled current, wherein the scaled current is determined by dividing a current flowing through the LS device by a ratio of an area of the LS device to an area of the pilot device; and sink negative current through the on-die capacitor.

Example 12: The system of any one of examples 9 to 11, wherein the circuit is further configured to input the current from the pilot device and a current of the LS device to a transimpedance amplifier; sample a signal generated by the transimpedance amplifier according to a clock signal; and output samples of the signal generated by the transimpedance amplifier to a current sensing node that combines samples of the signal generated by the transimpedance amplifier with samples corresponding to the calibrated signal.

Example 13: The system of any one of examples 9 to 12, wherein the circuit is further configured to apply a low-pass filter on the output signal from the power stage to generate the filtered signal; level shifting the filtered signal to generate a first level shifted signal; attenuate the first level shifted signal until a downslope of the first level shifted signal matches a downslope of a second level shifted signal, wherein the second level shifted signal is level shifted from the current from the pilot device, and wherein an amount of attenuation of the first level shifted signal is based on the calibration code; sample the attenuated first level shifted signal according to a clock signal; and output samples of the attenuated first level shifted signal to a current sensing node that combines samples of the attenuated first level shifted signal with samples corresponding to the current from the pilot device.

Example 14: The system of any one of examples 9 to 13, wherein the circuit is configured to generate a charge depletion signal indicating whether the LS device is on or off; generate a clock signal based on the charge depletion signal; and perform sampling according to the clock signal.

Example 15: The system of any one of examples 9 to 14, wherein the circuit is configured to sample a downslope of the current from the pilot device; sample a downslope of the calibrated signal; compare the sampled downslope of the current of the pilot device and the sampled downslope of the calibrated signal; and generate the calibration code based on a result of the comparison, wherein the calibration code indicates whether to increase or to decrease an amplitude of the filtered signal to generate the calibrated signal.

Example 16: A method for monitoring inductor current in a power stage, the method comprising filtering an output signal from a power stage to generate a filtered signal that is coherent with an inductor current through an inductor in the power stage; monitoring current from a pilot device integrated in a low-side (LS) device of the power stage; calibrating the filtered signal to generate a calibrated signal, wherein calibration of the filtered signal is based on a calibration code and based on the current from the pilot device; combining samples corresponding to the calibrated signal and samples corresponding to the current from the pilot device; and recreating the inductor current based on the combination of the samples.

Example 17: The method of example 16, further comprising generating the calibration code; and adjusting the calibration code based on the calibrated signal.

Example 18: The method of any one of examples 16 to 17, further comprising inputting the current from the pilot device and a current of the LS device to a transimpedance amplifier; sampling a signal generated by the transimpedance amplifier according to a clock signal; and outputting samples of the signal generated by the transimpedance amplifier to a current sensing node that combines samples of the signal generated by the transimpedance amplifier with samples corresponding to the calibrated signal.

Example 19: The method of any one of examples 16 to 18, further comprising applying a low-pass filter on the output signal from the power stage to generate the filtered signal; level shifting the filtered signal to generate a first level shifted signal; attenuating the first level shifted signal until a downslope of the first level shifted signal matches a downslope of a second level shifted signal, wherein the second level shifted signal is level shifted from the current from the pilot device, and wherein an amount of attenuation of the first level shifted signal is based on the calibration code; sampling the attenuated first level shifted signal according to a clock signal; and outputting samples of the attenuated first level shifted signal to a current sensing node that combines samples of the attenuated first level shifted signal with samples corresponding to the current from the pilot device.

Example 20: The method of any one of examples 16 to 19, further comprising sampling a downslope of the current from the pilot device; sampling a downslope of the calibrated signal; comparing the sampled downslope of the current of the pilot device and the sampled downslope of the calibrated signal; and generating the calibration code based on a result of the comparison, wherein the calibration code indicates whether to increase or to decrease an amplitude of the filtered signal to generate the calibrated signal.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements, if any, in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A semiconductor device comprising:
a first circuit configured to filter an output signal from a power stage to generate a filtered signal that is coherent with an inductor current through an inductor in the power stage;
a second circuit configured to generate a calibration code; and
a third circuit configured to monitor current from a pilot device integrated in a low-side (LS) device of the power stage,
wherein:
the first circuit is further configured to calibrate the filtered signal to generate a calibrated signal, wherein calibration of the filtered signal is based on the calibration code generated by the second circuit and based on the current from the pilot device; and
the second circuit is further configured to adjust the calibration code based on the calibrated signal generated by the first circuit, wherein a combination of samples corresponding to the calibrated signal and samples corresponding to the current from the pilot device recreates the inductor current.

2. The semiconductor device of claim 1, wherein the third circuit comprises:
a feedback resistor; and
a transimpedance amplifier connected in parallel to the feedback resistor, wherein the transimpedance amplifier comprises an on-die capacitor, and the transimpedance amplifier is configured to:
maintain the same voltage potential between the LS device and the pilot device such that all terminals of the LS device and the pilot device have equivalent voltages;
output a voltage equivalent to a product of a resistance of the feedback resistor and a scaled current, wherein the scaled current is determined by dividing a current flowing through the LS device by a ratio of an area of the LS device to an area of the pilot device; and
sink negative current through the on-die capacitor.

3. The semiconductor device of claim 1, wherein the pilot device shares a common drain and a common gate with the LS device of the power stage.

4. The semiconductor device of claim 1, wherein the pilot device is smaller than the LS device in the power stage.

5. The semiconductor device of claim 1, wherein the third circuit is further configured to:
input the current from the pilot device and a current of the LS device to a transimpedance amplifier;
sample a signal generated by the transimpedance amplifier based on the current from the pilot device and the current of the LS device according to a clock signal generated by the second circuit; and
output samples of the signal generated by the transimpedance amplifier to a current sensing node that combines samples of the signal generated by the transimpedance amplifier with samples corresponding to the calibrated signal.

6. The semiconductor device of claim 1, wherein the first circuit is further configured to:
apply a low-pass filter on the output signal from the power stage to generate the filtered signal;
level shifting the filtered signal to generate a first level shifted signal;
attenuate the first level shifted signal until a downslope of the first level shifted signal matches a downslope of a second level shifted signal, wherein the second level shifted signal is generated by the third circuit by level shifting the current from the pilot device, and wherein an amount of attenuation of the first level shifted signal is based on the calibration code;
sample the attenuated first level shifted signal according to a clock signal generated by the second circuit; and
output samples of the attenuated first level shifted signal to a current sensing node that combines samples of the attenuated first level shifted signal with samples corresponding to the current from the pilot device.

7. The semiconductor device of claim 1, wherein:
the third circuit is configured to generate a charge depletion signal indicating whether the LS device is on or off;
the second circuit is configured to generate a clock signal based on the charge depletion signal; and
the first circuit, the second circuit, and the third circuit are configured to perform sampling according to the clock signal.

8. The semiconductor device of claim 1, wherein the second circuit is configured to:
sample a downslope of the current from the pilot device monitored by the third circuit;
sample a downslope of the calibrated signal generated by the first circuit;
compare the sampled downslope of the current of the pilot device and the sampled downslope of the calibrated signal; and
generate the calibration code based on a result of the comparison, wherein the calibration code indicates to the first circuit to increase or to decrease an amplitude of the filtered signal to generate the calibrated signal.

9. A system comprising:
a power stage;
a controller configured to control the power stage;
a circuit configured to:
filter an output signal from the power stage to generate a filtered signal that is coherent with an inductor current through an inductor in the power stage;
monitor current from a pilot device integrated in a low-side (LS) device of the power stage;
calibrate the filtered signal to generate a calibrated signal, wherein calibration of the filtered signal is based on a calibration code and based on the current from the pilot device; and
combine samples corresponding to the calibrated signal and samples corresponding to the current from the pilot device,
wherein the controller is further configured to recreate the inductor current based on the combination of the samples.

10. The system of claim 9, wherein the circuit is configured to:
generate the calibration code; and
adjust the calibration code based on the calibrated signal.

11. The system of claim 9, wherein the circuit comprises:
a feedback resistor; and
a transimpedance amplifier connected in parallel to the feedback resistor, wherein the transimpedance amplifier comprises an on-die capacitor, and the transimpedance amplifier is configured to:
maintain the same voltage potential between the LS device and the pilot device such that all terminals of the LS device and the pilot device have equivalent voltages;
output a voltage equivalent to a product of a resistance of the feedback resistor and a scaled current, wherein the scaled current is determined by dividing a current flowing through the LS device by a ratio of an area of the LS device to an area of the pilot device; and
sink negative current through the on-die capacitor.

12. The system of claim 9, wherein the circuit is further configured to:
input the current from the pilot device and a current of the LS device to a transimpedance amplifier;
sample a signal generated by the transimpedance amplifier according to a clock signal; and
output samples of the signal generated by the transimpedance amplifier to a current sensing node that combines samples of the signal generated by the transimpedance amplifier with samples corresponding to the calibrated signal.

13. The system of claim 9, wherein the circuit is further configured to:
apply a low-pass filter on the output signal from the power stage to generate the filtered signal;
level shifting the filtered signal to generate a first level shifted signal;
attenuate the first level shifted signal until a downslope of the first level shifted signal matches a downslope of a second level shifted signal, wherein the second level shifted signal is level shifted from the current from the pilot device, and wherein an amount of attenuation of the first level shifted signal is based on the calibration code;
sample the attenuated first level shifted signal according to a clock signal; and
output samples of the attenuated first level shifted signal to a current sensing node that combines samples of the attenuated first level shifted signal with samples corresponding to the current from the pilot device.

14. The system of claim 9, wherein the circuit is configured to:
generate a charge depletion signal indicating whether the LS device is on or off;
generate a clock signal based on the charge depletion signal; and
perform sampling according to the clock signal.

15. The system of claim 9, wherein the circuit is configured to:
sample a downslope of the current from the pilot device;
sample a downslope of the calibrated signal;
compare the sampled downslope of the current of the pilot device and the sampled downslope of the calibrated signal; and
generate the calibration code based on a result of the comparison, wherein the calibration code indicates whether to increase or to decrease an amplitude of the filtered signal to generate the calibrated signal.

16. A method for monitoring inductor current in a power stage, the method comprising:
filtering an output signal from a power stage to generate a filtered signal that is coherent with an inductor current through an inductor in the power stage;
monitoring current from a pilot device integrated in a low-side (LS) device of the power stage;
calibrating the filtered signal to generate a calibrated signal, wherein calibration of the filtered signal is based on a calibration code and based on the current from the pilot device;
combining samples corresponding to the calibrated signal and samples corresponding to the current from the pilot device; and
recreating the inductor current based on the combination of the samples.

17. The method of claim 16, further comprising:
generating the calibration code; and
adjusting the calibration code based on the calibrated signal.

18. The method of claim 16, further comprising:
inputting the current from the pilot device and a current of the LS device to a transimpedance amplifier;
sampling a signal generated by the transimpedance amplifier according to a clock signal; and
outputting samples of the signal generated by the transimpedance amplifier to a current sensing node that combines samples of the signal generated by the transimpedance amplifier with samples corresponding to the calibrated signal.

19. The method of claim 16, further comprising:
applying a low-pass filter on the output signal from the power stage to generate the filtered signal;
level shifting the filtered signal to generate a first level shifted signal;
attenuating the first level shifted signal until a downslope of the first level shifted signal matches a downslope of a second level shifted signal, wherein the second level shifted signal is level shifted from the current from the pilot device, and wherein an amount of attenuation of the first level shifted signal is based on the calibration code;
sampling the attenuated first level shifted signal according to a clock signal; and
outputting samples of the attenuated first level shifted signal to a current sensing node that combines samples of the attenuated first level shifted signal with samples corresponding to the current from the pilot device.

20. The method of claim 16, further comprising:
sampling a downslope of the current from the pilot device;
sampling a downslope of the calibrated signal;
comparing the sampled downslope of the current of the pilot device and the sampled downslope of the calibrated signal; and
generating the calibration code based on a result of the comparison, wherein the calibration code indicates whether to increase or to decrease an amplitude of the filtered signal to generate the calibrated signal.
